(19) United States
(12) Patent Application Publication
(10) Pub. No.: US 2014/0360373 A1
(43) Pub. Date: Dec. 11, 2014

(54) AIR SEPARATION MODULE WITH REMOVABLE CORE

(71) Applicant: Hamilton Sundstrand Corporation, Windsor Locks, CT (US)

(72) Inventors: Frederick Peacos, North Scituate, RI (US); Kenneth Crawford, Manchester, CT (US)

(21) Appl. No.: 13/914,935

(22) Filed: Jun. 11, 2013

(51) Int. Cl. B01D 63/02; B01D 67/00

(52) U.S. Cl. CPC B01D 63/02; B01D 67/00
USPC 96/10; 96/4; 29/426.1

(57) ABSTRACT

A module for an inert gas system has a housing that includes a first portion, a second portion removable from the first portion, at least one fluid inlet port, and at least one fluid outlet port. The module also includes a replaceable selectively permeable membrane for separating components of a gaseous fluid placed within the housing.

### BACKGROUND

The present disclosure relates to a device for gas separation using a membrane adapted to selectively remove components from a fluid stream. More specifically, the present disclosure relates to a gas separation module with a removable membrane core.

The energy requirements of most modern aircraft are supplied by combusting aviation fuel, which is typically stored in fuel tanks within the wings of an aircraft. The fuel tanks also contain an explosive fuel/air mixture in the area above the fuel, otherwise known as the ullage. Many systems have been developed to reduce the danger of accidentally igniting this air/fuel mixture.

One way of addressing such a danger is to replace the explosive air/fuel mixture with a nonflammable inert gas, usually nitrogen. The on-board inert gas generating system provides the nonflammable inert gas by separating nitrogen from local, ambient air and replacing the fuel/air mixture in the ullage with the separated nitrogen.

For highly efficient and long-term stable operation, selectively gas permeable membranes in the inert gas generating system normally need the feed gas to be substantially free of contaminants such as heavy hydrocarbons. Contaminants can accumulate on the gas transfer surfaces of the membrane or otherwise interfere with transport of the feed gas components through the membrane. Over time, such interference can reduce the flow rate of the gas mixture through the membrane and/or the selectivity of the membrane. Separation performance can deteriorate rapidly to the extent that module should be replaced. Currently, this requires replacement of the entire gas separation module of the inert gas generating system.

### SUMMARY

In one embodiment, a module for an inert gas system has a housing that includes a first portion, a second portion removable from the first portion, at least one fluid inlet port, and at least one fluid outlet port. The module also includes a replaceable selectively permeable membrane for separating components of a gaseous fluid placed within the housing.

In an alternate embodiment, an inert gas separation system has a compressed fluid source and a fluid separation module. The module has a housing that includes a first portion, a second portion removable from the first portion, a first inlet fluidly connected to the compressed fluid source, and a first outlet. The module also includes a replaceable membrane extending at least partially through the housing and fluidly connected to the first inlet. The membrane is capable of separating components of a gaseous fluid placed within the housing.

In another embodiment, a method that includes removing a first portion of a housing of an inert gas separation module, removing a first membrane from the housing, inserting a second membrane into the housing, and reattaching the first portion of the housing is disclosed.

### BRIEF DESCRIPTION OF THE DRAWINGS

FIG. 1 is a schematic view of an on-board inert gas generating system.

FIG. 2 is a cross-sectional view of a separation module for the inert gas generating system with a removable core.

FIG. 3 is an exploded view of the separation module.

FIG. 4 is a partial cross-sectional view of the separation module connected to the inert gas generating system.

### DETAILED DESCRIPTION

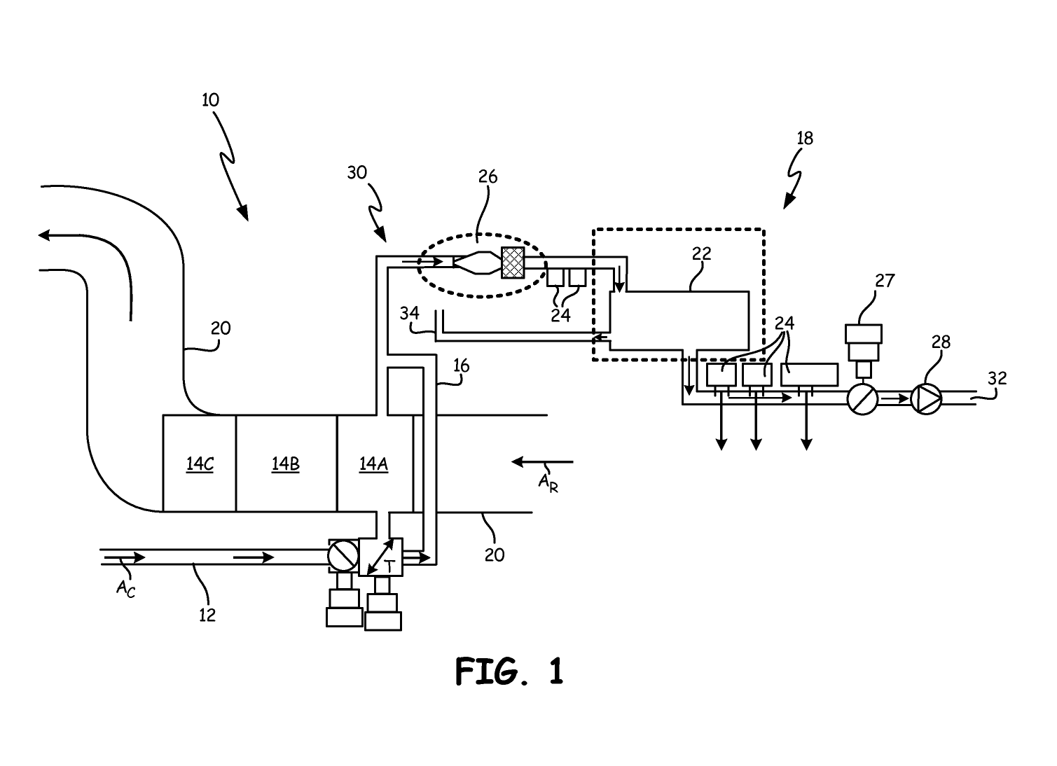

FIG. 1 is a schematic view of an on-board inert gas generating system 10. Inert gas system 10 includes compressed bleed air inlet 12, heat exchangers 14A-14C, bypass conduit 16, air separation module 18, and cooling conduit 20. As illustrated in FIG. 1, system 10 uses compressed bleed air A_{C} such as aircraft engine bleed air that is supplied under conditions of elevated temperature and elevated pressure to generate gas for inerting aircraft fuel tanks, cargo holds, and other void spaces on the aircraft. Compressed bleed air A_{C} is a fluid typically supplied from taps in the compressor section of the aircraft engines.

System 10 operates as compressed bleed air A_{C} from the engine is available, and thus avoids the use of auxiliary compressors or complex control valves. Compressed bleed air inlet 12 may contain a shut off valve, as well as temperature and/or pressure sensor(s) and associated valve(s) to direct compressed bleed air A_{C} through inert gas system heat exchanger 14A, or to direct compressed bleed air A_{C} through bypass conduit 16. Ram air A_{R} enters cooling conduit 20 and crosses flow with compressed bleed air A_{C} in heat exchanger 14A. Ram air A_{R} is air obtained from outside the aircraft via an air scoop, ram air turbine, or similar means for forcing airflow through cooling conduit 20 that is at a lower temperature than compressed bleed air A_{C}. Compressed bleed air A_{C} passing through heat exchanger 14A will thus be cooled prior to entering air separation module 18. In some embodiments, compressed bleed air A_{C} is passed directly through bypass conduit 16 and enters air separation module 18 in an unconditioned state.

Compressed bleed air A_{C} enters air separation module 18 which includes housing 22, and may optionally include sensors 24, ozone converter 26, flow control/shut off valve 27, and check valve 28. Compressed bleed air A_{C} is introduced at first end 30 of air separation module 18 into housing 22, flows through a membrane within housing 22 that preferentially separates inert gases, and nitrogen-enriched gas is produced from outlet 32 at the second end of air separation module 18. Compressed bleed air A_{C}, which may be pressurized, flows from heat exchanger 14A and enters ozone converter 26. Ozone converter 26 transforms ozone (O₃) into gaseous oxygen (O₂), and may optionally have multiple filters, such as a coalescing filter to remove particulate contaminants and moisture, and a carbon filter for removing hydrocarbons. Oxygen and other excess air are directed overboard of the engine at outlet 34. O-zone converter 26 may contain a filter that will remove contaminants from compressed bleed air AC prior to reaching removable core 36, thus increasing the usable life of the gas permeable membrane thereof. Shutoff valve 27 is provided adjacent second end 32 to stop the flow of gas from air separation module 18 if sensors 24 detect any system abnormalities. Sensors 24 may include pressure, flow, temperature, and/or oxygen level sensors known to those in the art.

Nitrogen-enriched gas produced by air separation module 18 is directed to the fuel tank and/or cargo hold. Shutoff valve 27 is preferably provided on the downstream side of air separation module 18 to control the flow rate through air separation module 18. One of the sensors 24 may be configured to provide signals representing oxygen content of the airflow leaving air separation module 18, while another sensor 24 may measure mass airflow leaving air separation module 18. Outlet 32 directs the nitrogen enriched gas to the fuel tank ullage and optionally to aircraft cargo hold as desired.

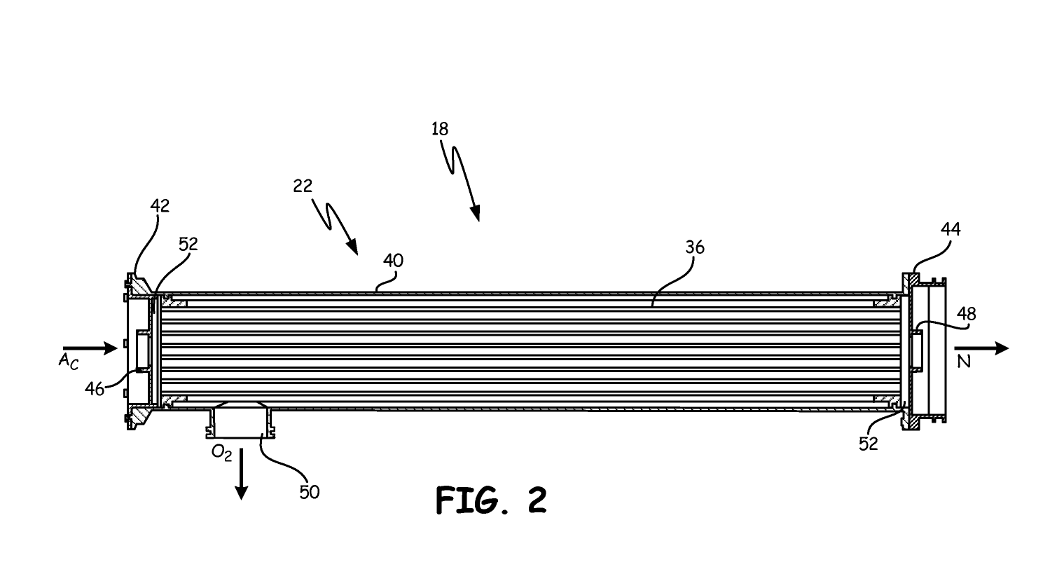

FIG. 2 is a cross-sectional view of air separation module 18 for inert gas generating system 10 having removable core 36 within housing 22. Housing 22 is comprised of main body portion 40, with first end cap 42 and second end cap 44. Housing 22 is constructed from a light weight, generally rigid material that is gas impermeable. Typical materials may include tungsten, aluminum, or polymers. First end cap 42 and second end cap 44 are portions that are secured to main body portion 40, with at least one end cap being removable therefrom. Ends caps 42 and 44 each contain a respective port 46 and 48, which act as fluid inlets or outlets. Additionally, housing 22 contains port 50 in main body portion 40.

Removable core 36 contains a gas separation membrane. Conventional gas separation membrane structures include the use of one or more elongated hollow fiber membrane bundles positioned within housing 22 such that there is open space 52 at the end upstream and downstream of the bundle(s). The feed gas mixture of compressed bleed air A_{C} to be separated enters housing 22 through port 46, and flows through the membrane via bores of the fibers. The membrane selectively allows gas to permeate the membrane, i.e., allows nitrogen N and other inert gases to pass through port 48, while stopping other gases, e.g., oxygen O₂.

In one embodiment, port 46 is the compressed bleed air inlet, port 48 is the nitrogen enriched gas N outlet, and port 50 is an outlet fluidly attached to an overboard discharge system. In this embodiment, compressed bleed air A_{C} will enter the inlet of port 46, and pass through removable core 36. Nitrogen rich gas N will pass through the membrane and exit port 48, while oxygen O₂ will be expelled through port 50 for discharge overboard of the engine. In an alternate embodiment, oxygen rich gas will be directed to another area of the aircraft for use thereof.

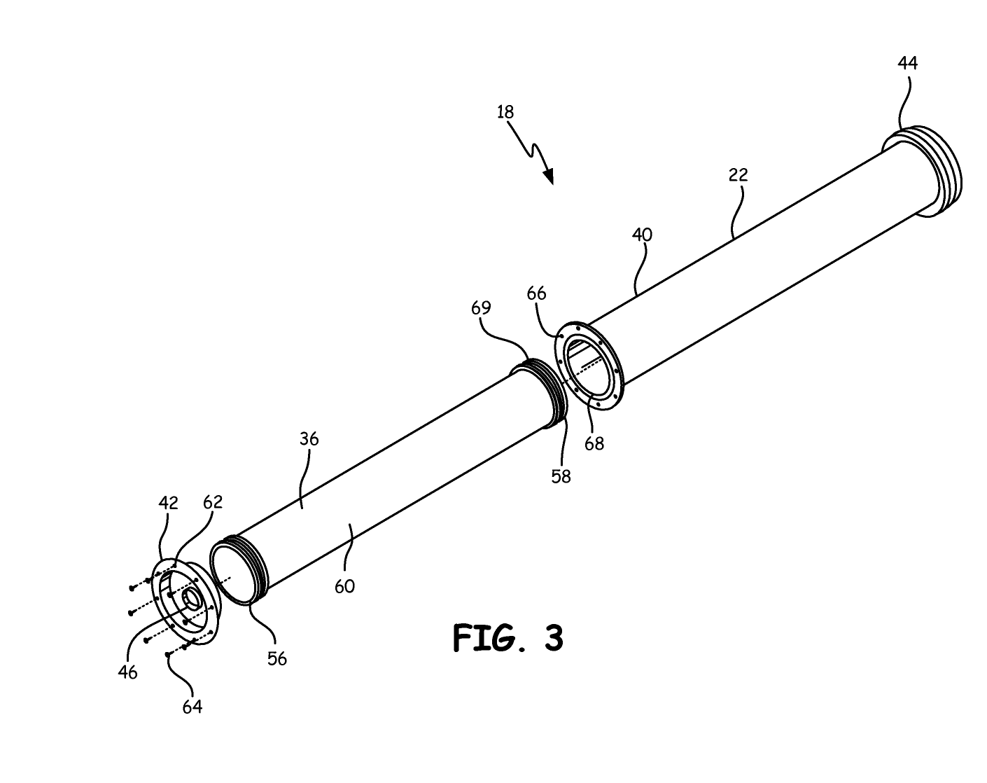

FIG. 3 is an exploded view of air separation module 18. Common elements previously described include housing 22 with main body portion 40, end cap 42 having port 46, end cap 44, and removable core 36. Removable core 36 contains gas permeable membrane 60 secured between caps 56 and 58. Gas permeable membrane 60 may be a series of hollow fiber membranes wrapped in a cylindrical shape, positioned in a corrugated arrangement, or a composite membrane structure known in the art. Caps 56 and 58 are attached to portions of fibers, and located at both ends of gas permeable membrane 60, and support the fibers of gas permeable membrane 60 to the desired shape and geometry. Although illustrated as being cylindrical, removable core 36 may be of any desired geometry.

End cap 42 is a portion of housing 22 that has been removed from main body portion 40. End cap 42 is a cup with a flange. The cup contains a nominally smaller outer diameter than the inner diameter of main body portion 40 to provide a nested configuration when installed. In alternate embodiments, the flange of end cap 42 attaches directly to the flange of main body portion 40. Both flanges may contain a plurality of apertures 62 and 66 to receive fasteners 64 to secure the components with respect to one another. Fasteners 64 are removable components, such as bolts, screws, pins, and the like, to facilitate removable attachment of end cap 42 to main body portion 40. End cap 44 contains a circumferential groove to permit attachment of end cap 44 to an adjacent component through a slip joint attachment. Although illustrated as being attached to main body portion 40, end cap 44 may also be removable therefrom. In an alternate embodiment, one of end cap 44 or end cap 42 is permanently secured to main body portion 40, such as by welding, or is integral therewith.

Seal 68 may be present between removable core 36 adjacent to end cap 42 and main body portion 40. Seal 68 is constructed from a resilient, gas impermeable material such as rubber, and prevents the escape of the pressurized gases within housing 22. Seal 68 is an O-ring, or in other embodiments, seal 68 is a gasket. A similar seal 69 may be present between removable core 36 adjacent to end cap 44 and main body portion 40. Removable core 36 is inserted into main body portion 40 of housing 22, and secured therein by end cap 42 through the use of removable fasteners. Thus, removable core 36 is replaceable.

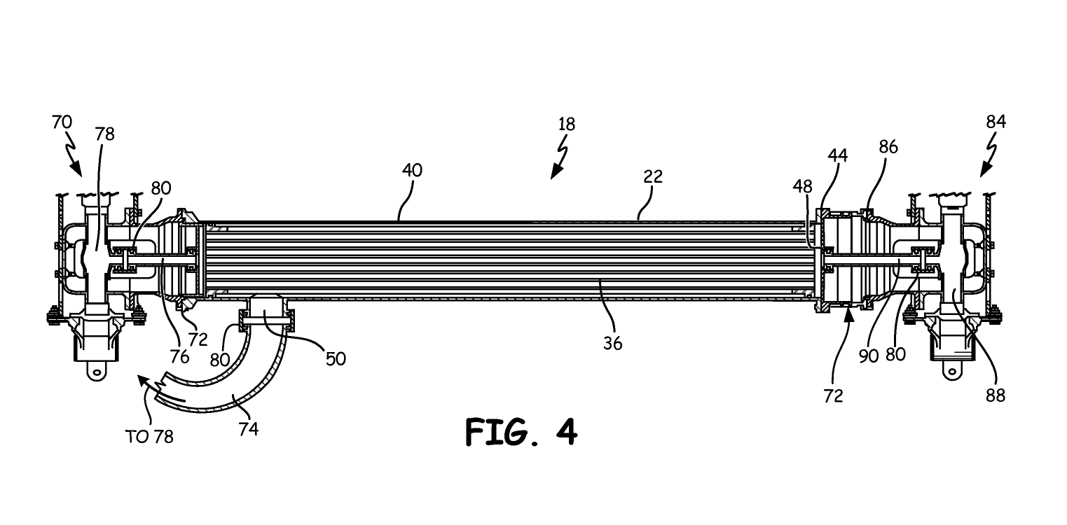

FIG. 4 is a partial cross-sectional view of air separation module 18 connected to inert gas generating system 10. Housing 22 and removable core 36 are illustrated in cross-section, and are similar to the structures previously described. Manifold 70 is attached to end cap 42 via joint 72, which may be a v-band or slip joint arrangement. Manifold 70 directs compressed bleed air A_{C} into air separation module 18 through inlet tube 76, which attaches to an inlet such as port 46. Additionally, manifold 70 holds discharge assembly 78 that is connected to port 50 by tube 74. Port 50 acts as the outlet for the oxygen enriched gas produced. Manifold end of tube 76 and 90 as well as the junctions at discharge assembly 78 (not visible in this view) and port 50 contain quick disconnect fluid couplings 80. Tubes 76 and 90 are inserted at ports 46 and 48 utilizing o-ring seals, and are trapped and retained in position by quick disconnect fluid couplings 80 on adjacent ends of tubes 76 and 90. Tubes 74, 76, 90 and quick disconnect fluid couplings 80 are known structures to those of skill in the art. Housing 22 encases removable core 36 adjacent the inlet of port 46 and the outlet of port 48.

Manifold 84 is attached to end cap 44 through slip joint 86. Manifold 84 contains inert gas distribution system 88 fluidly connected to housing 22 by tube 90. Tube 90 is connected to port 48 and inert gas distribution system 88 through quick disconnect fluid couplings 80. Compressed bleed air will enter air separation module 18, pass through removable core 36, which selectively allows inert gases to pass therethrough, and inert gas will exit the module at outlet port 48. The inert gas may then be utilized for fuel tank inerting, or other needs on the aircraft. Fluid able to pass through the membrane of removable core 36 will be forced through outlet 50, and discharged overboard.

With the described design, the removable core may be replaced periodically without the requirement of replacing the entire air separation module. To replace the membrane core, the tubes are removed by undoing the quick disconnect couplings. Next, the joints securing the air separation module to the manifolds are undone. The air separation module may then be removed, and one or both end caps may be disassembled. This allows access to the removable core, which is pulled from the housing. A new membrane core is then inserted, and the module is reassembled and secured back to the manifolds. The modular design with a removable core allows for quick and inexpensive maintenance for the inert gas system. Further, the housing of the air separation module is reusable in the same engine, unlike the existing systems that require replacement of the entire module. The embodiments described herein allow for in-line replacement of the membrane core.

Discussion of Possible Embodiments

The following are non-exclusive descriptions of possible embodiments of the present invention.

A module for an inert gas system has a housing that includes a first portion, a second portion removable from the first portion, at least one fluid inlet port, and at least one fluid outlet port. The module also includes a replaceable selectively permeable membrane for separating components of a gaseous fluid placed within the housing.

The module of the preceding paragraph can optionally include, additionally and/or alternatively, any one or more of the following features, configurations and/or additional components:

a seal between the first portion and second portion of the housing;

wherein the at least one fluid inlet port is capable of receiving compressed fluid flow;

wherein the at least one fluid inlet port is located on the second portion;

wherein the at least one fluid outlet port is configured to expel inert gas enriched fluid;

a second outlet port configured to expel oxygen enriched fluid;

wherein the first portion and second portion are secured with removable fasteners; and/or

wherein the replaceable selectively permeable membrane comprises of an elongated bundle having two ends, the bundle including a plurality of fibers, and each end having a respective cap adapted to secure the plurality of fibers in fluid communication.

In an alternate embodiment, an inert gas separation system has a compressed fluid source and a fluid separation module. The module has a housing that includes a first portion, a second portion removable from the first portion, a first inlet fluidly connected to the compressed fluid source, and a first outlet. The module also includes a replaceable membrane extending at least partially through the housing and fluidly connected to the first inlet. The membrane is capable of separating components of a gaseous fluid placed within the housing.

The system of the preceding paragraph can optionally include, additionally and/or alternatively, any one or more of the following features, configurations and/or additional components:

wherein the replaceable membrane comprises of an elongated bundle having two ends, the bundle including a plurality of fibers, and each end having a respective cap adapted to secure the plurality of fibers in fluid communication within the housing;

a filter between the compressed fluid source and the first inlet;

a seal between the first portion and the second portion of the housing;

wherein the first inlet comprises a quick disconnect fluid coupler;

wherein the first inlet is located in the second portion;

wherein the first outlet is located in the second portion;

a third portion removable from the first portion;

a seal between the first portion and the third portion of the housing; and/or

wherein the first portion is connected to the second portion and the third portion with removable fasteners.

In another embodiment, a method that includes removing a first portion of a housing of an inert gas separation module, removing a first membrane from the housing, inserting a second membrane into the housing, and reattaching the first portion of the housing is disclosed.

The method of the preceding paragraph can optionally include, additionally and/or alternatively, any one or more of the following steps, features, configurations and/or additional components:

removing at least one fastener; and

disconnecting a fluid attachment from the first portion of the housing.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A module for an inert gas system comprising:
a housing including:
a first portion;
a second portion removable from the first portion;
at least one fluid inlet port; and
at least one fluid outlet port; and
a replaceable selectively permeable membrane for separating components of a gaseous fluid placed within the housing.

2. The module of claim 1 further comprising:
a seal between the first portion and second portion of the housing.

3. The module of claim 1 wherein the at least one fluid inlet port is capable of receiving compressed fluid flow.

4. The module of claim 3 wherein the at least one fluid inlet port is located on the second portion.

5. The module of claim 1 wherein the at least one fluid outlet port is configured to expel inert gas enriched fluid.

6. The module of claim 5 further comprising:
a second fluid outlet port configured to expel oxygen enriched fluid.

7. The module of claim 1 wherein the first portion and second portion are secured with removable fasteners.

8. The module of claim 1 wherein the replaceable selectively permeable membrane comprises an elongated bundle having two ends, the bundle including a plurality of fibers, and each end having a respective cap adapted to secure the plurality of fibers in fluid communication.

9. An inert gas separation system comprising:
a compressed fluid source;
a fluid separation module comprising:
a housing including:
a first portion;
a second portion removable from the first portion;
a first inlet fluidly connected to the compressed fluid source; and
a first outlet; and
a replaceable membrane extending at least partially through the housing and fluidly connected to the first inlet, wherein the membrane is capable of separating components of a gaseous fluid placed within the housing.

10. The system of claim 9 wherein the replaceable membrane comprises an elongated bundle having two ends, the bundle including a plurality of fibers, and each end having a respective cap adapted to secure the plurality of fibers in fluid communication within the housing.

11. The system of claim 9 further comprising:
a filter between the compressed fluid source and the first inlet.

12. The system of claim 9 further comprising:
a seal between the first portion and the second portion of the housing.

13. The system of claim 9 wherein the first inlet comprises a quick disconnect fluid coupler.

14. The system of claim 9 wherein the first inlet is located in the second portion.

15. The system of claim 9 further comprising a second outlet is located in the first portion.

16. The system of claim 9 wherein the housing further comprises:
a third portion removable from the first portion.

17. The system of claim 16 further comprising:
a seal between the first portion and the third portion of the housing.

18. The system of claim 17 wherein the first portion is connected to the second portion and the third portion with removable fasteners.

19. A method comprising:
removing a first portion of a housing of an inert gas separation module;
removing a first membrane from the housing;
inserting a second membrane into the housing;
reattaching the first portion of the housing.

20. The method of claim 19 wherein removing the first portion of the housing includes:
removing at least one fastener; and
disconnecting a fluid attachment from the first portion of the housing.
